(19) United States
(12) Patent Application Publication
(10) Pub. No.: US 2017/0085633 A1
(43) Pub. Date: Mar. 23, 2017

(54) METHOD AND APPARATUS FOR SAVING CLOUD SERVICE TRAFFIC USING PEER-TO-PEER CONNECTION

(71) Applicant: SUNSHINE APP, INC., San Francisco, CA (US)

(72) Inventors: Ho Sun KIM, Seongnam-si (KR); Heung Ju KIM, Yongin-si (KR)

(21) Appl. No.: 14/920,288

(22) Filed: Oct. 22, 2015

(30) Foreign Application Priority Data
Sep. 22, 2015 (KR) 10-2015-0133601

(51) Int. Cl. H04L 29/08; H04L 12/803

(52) U.S. Cl. CPC H04L 67/104; H04L 47/125; H04L 67/34; H04L 67/02

(57) ABSTRACT

According to an aspect of present invention provides method of sharing contents, method comprising, receiving an integrated link for accessing any one of a first link and a second link from an external device and attempting to access a first link through an integrated link and then attempting to access a second link only when failing to access first link, wherein first link is used to receive content through peer-to-peer (p2p) data transmission and reception, and second link is used to download content from a data storage device which is connected to a network so as to provide a content storage service.

This application claims priority from Korean Patent Application No. 10-2015-0133601 filed on Sep. 22, 2015 in the Korean Intellectual Property Office, the disclosure of which is incorporated herein by reference in its entirety.

### BACKGROUND OF THE INVENTION

1. Field of the Invention

The present invention relates to a method and apparatus for saving cloud service traffic using peer-to-peer (p2p) connection, and more particularly, to a method and apparatus for reducing the demand for network traffic and storage in a cloud storage service by replacing some traffic of the cloud storage service with p2 p connection.

2. Description of the Related Art

Peer-to-peer (p2p) connection goes beyond the conventional concept of a server and a client or a supplier and a consumer. In the p2 p connection, individual computers are directly connected to each other to exchange information directly with each other. Therefore, the p2 p connection is a network connection in which all participants are suppliers as well as consumers. The p2 p connection can be implemented largely in two ways. One is to establish a connection between individuals with the help of a server to some degree, and the other is for clients to be directly connected to each other without a server by sharing personal information (such as Internet protocol (IP) addresses) with each other in advance. In the former case, personal information is also exchanged between the individuals as in the latter case after the individuals are connected to each other.

A cloud storage service is provided in various forms. The cloud storage service is a service that enables network-based data storage. The cloud storage service is generally implemented using a plurality of storage devices connected to a network and a service server which manages the storage devices and interfaces with users.

As content becomes digitalized, the number of content viewing devices connected to the Internet increases, and one user can use a number of content viewing devices, the cloud storage service triggers an increasingly greater demand for network traffic and storage in order to synchronize content stored in various content viewing devices or share the content among users.

### SUMMARY OF THE INVENTION

Aspects of the present invention provide a content sharing method and apparatus.

Aspects of the present invention also provide a method of saving traffic and storage space required in a cloud storage service and an apparatus for executing the method.

Aspects of the present invention also provide a billing method based on the performance of saving traffic and storage space required in a cloud storage service and an apparatus for executing the method.

Aspects of the present invention also provide a method of rewarding a user who contributed to the saving of traffic and storage space required in a cloud storage service and an apparatus for executing the method.

However, aspects of the present invention are not restricted to the one set forth herein. The above and other aspects of the present invention will become more apparent to one of ordinary skill in the art to which the present invention pertains by referencing the detailed description of the present invention given below.

According to an aspect of the present invention, there is provided a content sharing method including: receiving an integrated link for accessing any one of a first link and a second link from an external device; and attempting to access the first link through the integrated link and then attempting to access the second link only when failing to access the first link, wherein the first link is used to receive content through peer-to-peer (p2p) data transmission and reception, and the second link is used to download content from a data storage device which is connected to a network so as to provide a content storage service. The content sharing method may be performed by, e.g., a receiver terminal which receives content.

According to another aspect of the present invention, there is provided a content sharing method including: receiving from a transmitter terminal an integrated link used to obtain a p2 p link of content stored in the transmitter terminal and a cloud link for downloading the content uploaded to a cloud service server; accessing a content sharing relay server using the integrated link and receiving the p2 p link and the cloud link from the content sharing relay server; attempting to receive the content using the p2 p link; and attempting to download the content using the cloud link when failing to receive the content using the p2 p link. The content sharing method may be performed by, e.g., a receiver terminal which receives content.

According to another aspect of the present invention, there is provided a content sharing relay method including: receiving from a transmitter terminal a p2 p link for content stored in the transmitter terminal and a cloud link for downloading the content uploaded to a cloud service server; generating an integrated link using the p2 p link and the cloud link; and, in response to access by a receiver terminal through the integrated link, universal resource locator (URL)-redirecting the integrated link to the p2 p link when the transmitter terminal is able to communicate using the p2 p link and URL-redirecting the integrated link to the cloud link when the transmitter terminal is unable to communicate using the p2 p link. The content sharing relay method may be performed by, e.g., a content sharing relay server which relays content sharing.

According to another aspect of the present invention, there is provided a content sharing method including: receiving an integrated link used to access a p2 p link for content stored in a transmitter terminal from the transmitter terminal by using a receiver terminal; first attempting to access the p2 p link through the integrated link by using the receiver terminal; receiving content from the transmitter terminal using the p2 p link after accessing the p2 p link by using the receiver terminal; and attempting to access a cloud link, which has been newly matched to the integrated link as a result of updating the integrated link, through the integrated link when disconnected from the transmitter terminal while receiving the content from the transmitter terminal by using the receiver terminal, wherein the cloud link is used to download the content uploaded to a cloud service server. The content sharing method may be performed by, e.g., the receiver terminal which receives content.

According to another aspect of the present invention, there is provided a content sharing method including: generating a p2 p link indicating stored content; starting to upload the content to a cloud service server; requesting a content sharing relay server to generate an integrated link by transmitting the p2 p link to the content sharing relay server before the uploading of the content is completed; transmitting the integrated link to a receiver terminal directly or through the content sharing relay server before the uploading of the content is completed; starting to transmit the content using the p2 p link when requested by the receiver terminal to transmit the content using the p2 p link; and cancelling the uploading of the content to the cloud service server when the transmitting of the content using the p2 p link is completed before the uploading of the content to the cloud service server is completed. The content sharing method may be performed by, e.g., a transmitter terminal which transmits content to other users.

According to another aspect of the present invention, there is provided a billing method for the saving of cloud service traffic. The billing method includes: generating an integrated link used to obtain a p2 p link of content stored in a transmitter terminal and a cloud link for downloading the content uploaded to a cloud service server; collecting information about the performance of receiving the content from the transmitter terminal using the p2 p link instead of downloading the content from the cloud service server; and generating billing data for an operator of the cloud service server using the collected information about the performance. The billing method may be performed by, e.g., a content sharing relay server which relays content sharing.

According to another aspect of the present invention, there is provided a rewarding method for the saving of cloud service traffic. The rewarding method includes: generating an integrated link used to obtain a p2 p link of content stored in a transmitter terminal and a cloud link for downloading the content uploaded to a cloud service server; collecting from a receiver terminal which accessed through the integrated link, information about the performance of receiving the content from the transmitter terminal using the p2p link instead of downloading the content from the cloud service server; and issuing a reward for at least one of a user account of the transmitter terminal and a user account of the receiver terminal by using the collected information about the performance. The rewarding method may be performed by, e.g., a content sharing relay server which relays content sharing.

According to another aspect of the present invention, there is provided an apparatus for saving cloud service traffic. The apparatus includes: a network interface; one or more processors; a memory which is loaded with a computer program executed by the processors; a storage which stores an integrated link table including a p2 p link of content stored in a transmitter terminal, a cloud link for downloading the content uploaded to a cloud service server, and matching information of an integrated link provided to a receiver terminal to access the p2 p link and the cloud link, wherein the computer program includes: an operation of receiving the p2 p link and the cloud link through the network interface and generating the integrated link to access the p2 p link and the cloud link; and an operation of, in response to access by the receiver terminal through the integrated link, URL-redirecting the integrated link to the p2 p link when the transmitter terminal is able to communicate using the p2 p link and URL-redirecting the integrated link to the cloud link when the transmitter terminal is unable to communicate using the p2 p link.

### BRIEF DESCRIPTION OF THE DRAWINGS

The above and other aspects and features of the present invention will become more apparent by describing in detail exemplary embodiments thereof with reference to the attached drawings, in which:

FIG. 1 illustrates a conventional sharing process using a cloud storage service;

FIG. 2 illustrates the configuration of a content sharing system according to an embodiment of the present invention;

FIGS. 3 through 7 are flowcharts illustrating a content sharing method according to another embodiment of the present invention;

FIGS. 8 through 11 are flowcharts illustrating a content sharing method according to another embodiment of the present invention;

FIG. 12 is a flowchart illustrating a billing method for the saving of cloud service traffic according to another embodiment of the present invention;

FIG. 13 is a conceptual diagram illustrating, in greater detail, the content sharing method described above with reference to FIGS. 3 through 7;

FIG. 14 is a conceptual diagram illustrating, in greater detail, the content sharing method described above with reference to FIGS. 8 through 11;

FIG. 15 is a block diagram of a content sharing relay server according to another embodiment of the present invention; and

FIG. 16 illustrates the hardware configuration of the content sharing relay server.

### DETAILED DESCRIPTION OF THE INVENTION

Advantages and features of the one or more exemplary embodiments and methods of accomplishing the same may be understood more readily by reference to the following detailed description of the exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those skilled in the art, and the present invention will only be defined by the appended claims. Like reference numerals refer to like elements throughout the specification.

The terminology used herein is for the purpose of describing one or more exemplary embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It will be understood that when an element or layer is referred to as being “on”, “connected to” or “coupled to” another element or layer, it may be directly on, connected or coupled to the other element or layer, or intervening elements or layers may be present. In contrast, when an element is referred to as being “directly on”, “directly connected to” or “directly coupled to” another element or layer, there are no intervening elements or layers present. As used herein, the term “and/or” includes any and all combinations of one or more of the associated listed items.

It will be understood that, although the terms first, second, and the like, may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

One or more exemplary embodiments may be described herein with reference to cross-section illustrations that are schematic illustrations of idealized embodiments (and intermediate structures). As such, variations from the shapes of the illustrations as a result, for example, of manufacturing techniques and/or tolerances, are to be expected. Thus, these one or more exemplary embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the exemplary figures are schematic in nature and their shapes are not intended to illustrate the actual shape of a region of a device and are not intended to limit the scope of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

A logic or a routine in one or more exemplary embodiments may indicate a series of operations executable by a processor and is not limited to an example prepared by a predetermined programming language.

1. Content Sharing System

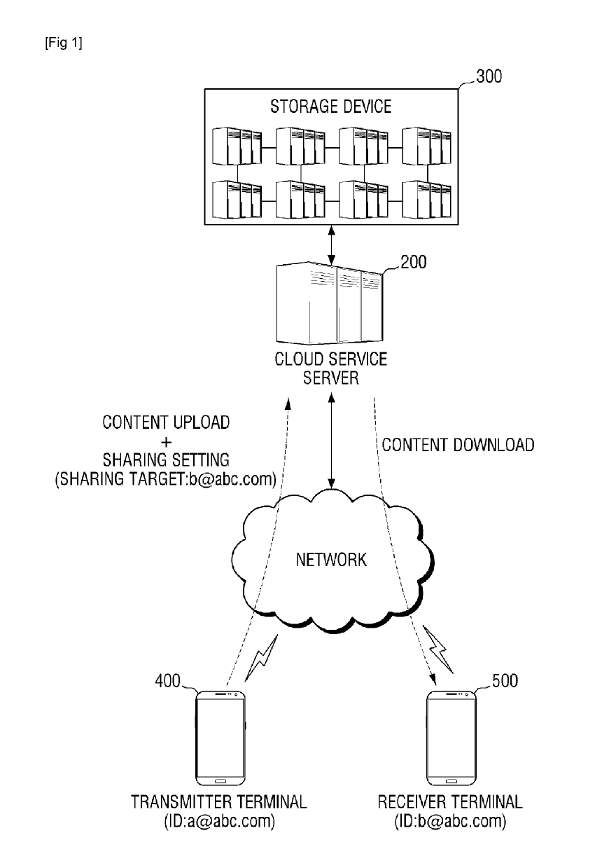

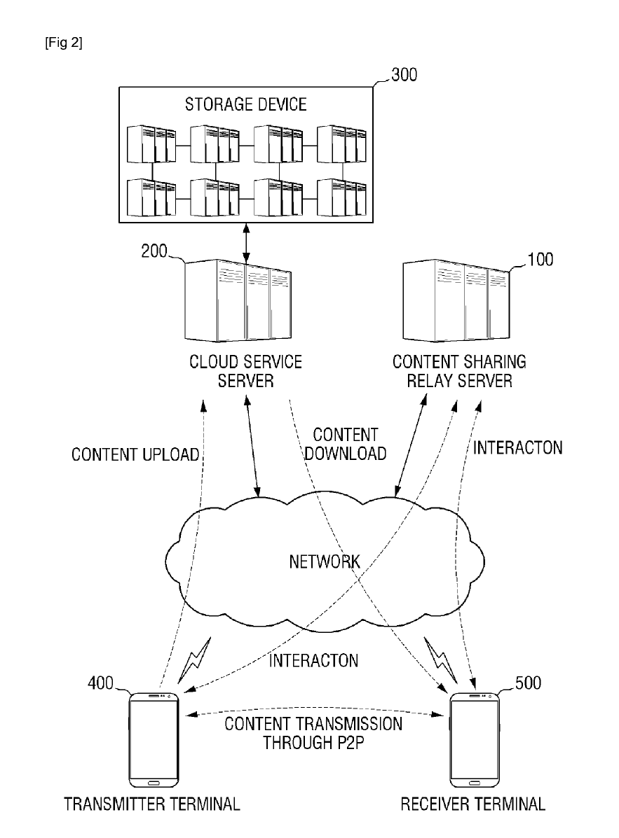

A content sharing system and method according to an embodiment of the present invention will be roughly described with reference to FIGS. 1 and 2.

FIG. 1 illustrates a conventional sharing process using a cloud storage service. To avoid unnecessary confusion, the cloud storage service will hereinafter be referred to as a cloud service.

A cloud service server 200 is connected to a storage device 300 which stores content uploaded by user terminals and provides a cloud service to the user terminals. In FIG. 1, a transmitter terminal 400 and a receiver terminal 500 from among the user terminals are illustrated. It is assumed that an ID of a user using the transmitter terminal 400 is ‘a@abc.com’ and that an ID of a user using the receiver terminal 500 is ‘b@abc.com.’ The IDs are used to log into the cloud service.

The cloud service provides a content sharing function to other users. A user who desires to share content may designate a sharing target. For example, the user may designate a particular user, all users included in a particular group, or a plurality of users. Referring to FIG. 1, the user (a@abc.com) of the transmitter terminal 400 may upload content to the storage device 300 through the cloud service server 200 and give the ID ‘b@abc.com’ the authority to access the uploaded content through sharing setting. In this case, not only the user (a@abc.com) of the transmitter terminal 400 but also the user (b@abc.com) of the receiver terminal 500 can download the uploaded content.

However, the conventional sharing process using the cloud service described above with reference to FIG. 1 has several problems in the sharing of large-volume content such as high-definition movies. First, it inevitably takes a long time to upload large-volume content. Therefore, the large-volume content can be shared only after a waiting period until the large-volume content is uploaded. In addition, a cloud service provider has the burden of network traffic and storage space. Embodiments of the present invention have been newly invented to solve the above problems.

A content sharing system and method according to an embodiment of the present invention will now be described with reference to FIG. 2.

Unlike the conventional content sharing method and system using the cloud service illustrated in FIG. 1, the content sharing method and system according to the current embodiment additionally utilize peer-to-peer (p2p) connection. That is, when p2p connection can be used, content is not downloaded from a storage device 300 of a cloud service. Instead, the content is received one-to-one using the p2 p connection. In other words, when two channels for p2 p connection and cloud storage are all available, the p2p connection is preferentially selected. Accordingly, a cloud service provider can save the cost of network traffic that accompanies the downloading of the content.

In some embodiments of the present invention, when content is to be shared only with a sharing target which receives content through p2 p connection, there is no need to upload the content to the storage device 300. Even while the content is being uploaded to the storage device 300, when the transmission of the content through the p2 p connection is completed, the uploading of the content is cancelled. Therefore, a cloud service provider can save the maintenance cost of the storage device 300 which accompanies the storing of the content.

In addition, in some embodiments of the present invention, while a receiver terminal 500 is receiving content through p2 p connection, the p2 p connection can be interrupted due to, e.g., power-off of a transmitter terminal 400. In this case, the receiver terminal 500 can automatically continue to receive the content from the storage device 300 from where it was interrupted. That is, according to the current embodiment, the instability of the p2 p connection can be compensated for by the cloud service.

The transmitter terminal 400 and the receiver terminal 500 can establish a session for the p2 p connection through interactions with a content sharing relay server 100. The interactions include a first interaction for generating an integrated link to obtain a p2 p link to content stored in the transmitter terminal 400 and a cloud link used to download the content uploaded to a cloud service server 200 and a second interaction for sending the integrated link to a sharing target.

For the above interactions, the transmitter terminal 400 and the receiver terminal 500 may call an application programming interface (API) to request the content sharing relay server 100 to provide a particular function. The API may be included in a software development kit (SDK) distributed by a provider of the content sharing relay server 100. The API can be embedded in various application programs. For example, the API can be embedded in an application program for using the cloud service.

To perform a function related to the second interaction, the content sharing relay server 100 may manage service users through a membership registration procedure and support a content sharing function between service users or between multiple terminals possessed by one service user.

The content sharing relay server 100 helps the generation of a p2 p connection between the transmitter terminal 400 and the receiver terminal 500. When at least any one of the transmitter terminal 400 and the receiver terminal 500 belongs to a universal plug and play (UPnP) network, the content sharing relay server 100 may serve as a p2p-to-UPnP proxy gateway. A p2 p connection relay method using the p2p-to-UPnP proxy gateway is a technology widely known to those of ordinary skill in the art to which the present invention pertains and disclosed in Korean Patent Publication No. 2005-0088699, entitled “A P2P-to-UPnP Proxy Gateway Architecture for Home Multimedia Content Distribution” (KSII Transactions on Internet and Information System (TIIS) Vol. 6 No. 1, 2012.1, 404-423 (20 pages)). Therefore, a detailed description of the p2 p connection relay method using the p2p-to-UPnP proxy gateway is omitted.

In FIG. 2, the cloud service server 200 and the content sharing relay server 100 are illustrated as separate devices. However, the content sharing relay server 100 can also be a module included in the cloud service server 200. In this case, it is meaningless to distinguish a user of a cloud service from a user of a content sharing relay service. Therefore, the user of the cloud service is the user of the content sharing relay service.

The content sharing method described above with reference to FIG. 2 can be understood as including the following operations.

First, the transmitter terminal 400 provides a first link and a second link to the content sharing relay server 100. The first link is used to receive content through p2p data transmission and reception, and the second link is used to download content from a data storage device which is connected to a network so as to provide a content storage service. For ease of understanding, the first link will hereinafter be referred to as a p2p link, and the second link will hereinafter be referred to as a cloud link. The p2 p link may be generated when the transmitter terminal 400 executes an API (included in an SDK distributed by a provider of the content sharing relay server 100) for generating a p2 p link. The cloud link may be received from the cloud service server 200 after the transmitter terminal 400 uploads content to the storage device 300 through the cloud service server 200.

Next, the content sharing relay server 100 generates an integrated link used to access any one of the p2 p link and the cloud link. The integrated link is a uniform resource locator (URL) and indicates the content sharing relay server 100. That is, when a terminal selects the integrated link, it is connected to the content sharing relay server 100. The content sharing relay server 100 may transmit the integrated link to the transmitter terminal 400, the receiver terminal 500, or both the transmitter terminal 400 and the receiver terminal 500.

Next, the receiver terminal 500 receives the integrated link. An external device may be any one of the transmitter terminal 400 and the content sharing relay server 100.

The receiver terminal 500 first attempts to access the p2 p link through the integrated link. Only when failing to access the p2 p link, the receiver terminal 500 attempts to access the cloud link. In an embodiment, the content sharing relay server 100 may URL-redirect the integrated link to any one of the p2 p link and the cloud link. In another embodiment, the content sharing relay server 100 may search for a corresponding p2 p link and cloud link using information included in the integrated link and then transmit the p2 p link and the cloud link to a terminal that accessed the content sharing relay server 100 through the integrated link. When content to be shared has already been uploaded to the cloud service, the cloud link may exist. However, when the integrated link is generated while the content to be shared is being uploaded to the cloud service, the cloud link may not exist. In this case, the content sharing relay server 100 may URL-redirect the integrated link to the cloud link or transmit the cloud link to the receiver terminal 500 which accessed the content sharing relay server 100 through the integrated link.

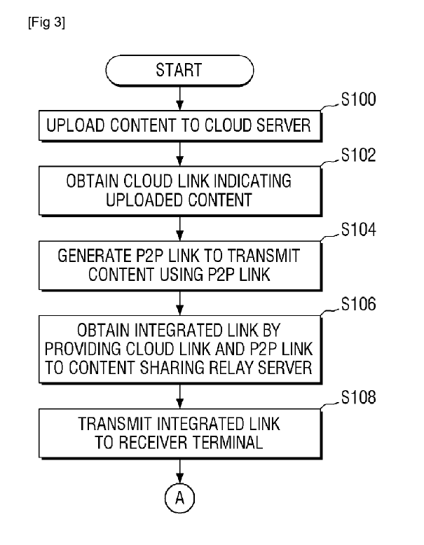

Embodiments of the present invention will now be described in detail with reference to FIGS. 3 through 11.

2. Sharing after the Completion of Content Uploading

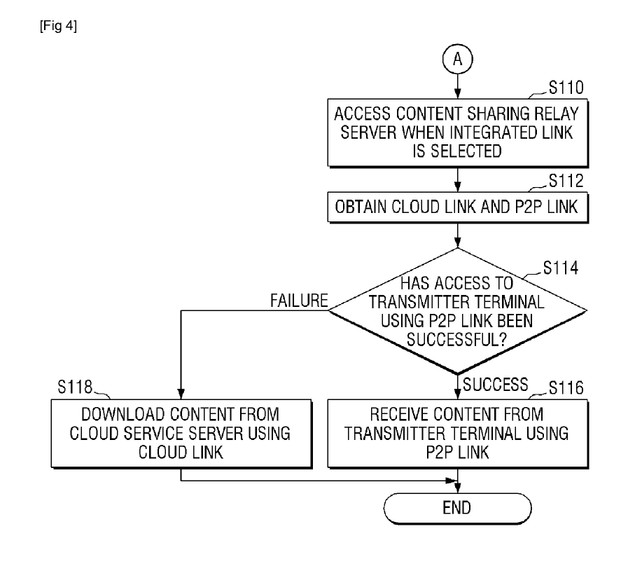

FIGS. 3 through 7 are flowcharts illustrating a content sharing method according to another embodiment of the present invention. The current embodiment is based on the assumption that content sharing is started after the completion of content uploading to a cloud service. FIG. 3 is a flowchart illustrating a method performed by a transmitter terminal which stores content to be shared. FIGS. 4 through 7 are flowcharts illustrating methods selectively performed by a receiver terminal after the method of FIG. 3 is performed.

Referring to FIG. 3, a transmitter terminal uploads content to a cloud service server (operation S100) and receives a cloud link indicating the uploaded content from the cloud service server (operation S102). In addition, the transmitter terminal generates a p2 p link needed to transmit the content stored therein through p2 p connection by calling an API (included in the SDK described above) for generating a p2 p link (operation S104).

Next, the transmitter terminal requests a content sharing relay server to generate an integrated link by calling an API (included in the SDK) for requesting the generation of an integrated link and receives the integrated link generated by the content sharing relay server (operation S106). The API for requesting the generation of the integrated link is a parameter and requires the p2 p link and the cloud link. In addition, when the API for requesting the generation of the integrated link is called, the transmitter terminal transmits the p2 p link and the cloud link to the content sharing relay server.

Next, the transmitter terminal transmits the integrated link to a receiver terminal (operation S108). The transmitter terminal may request the content sharing relay server to transmit the integrated link to the receiver terminal or may directly transmit the integrated link to the receiver terminal through an e-mail, a messenger, a short message service (SMS), etc.

FIG. 4 is a method performed by the receiver terminal which receives the integrated link.

Referring to FIG. 4, when receiving a user's input for selecting the integrated link, the receiver terminal accesses the content sharing relay server through the integrated link (operation S110). Then, the receiver terminal receives the p2 p link and the cloud link from the content sharing relay server (operation S112).

The receiver terminal accesses the transmitter terminal using the p2 p link (operation S114). When successfully accessing the transmitter terminal, the receiver terminal receives the content from the transmitter terminal using the p2 p link (operation S116). Only when failing to access the transmitter terminal, the receiver terminal downloads the content from the cloud service server using the cloud link (operation S118).

That is, according to the current embodiment, even if content to be shared has been uploaded through a cloud service, if p2 p connection is possible, the content to be shared is received through the p2 p connection. Therefore, network traffic of the cloud service can be saved.

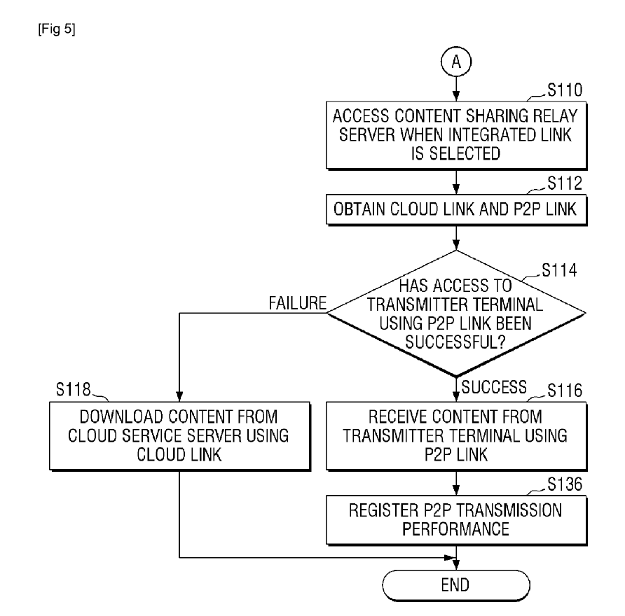

FIG. 5 is also a method performed by the receiver terminal which receives the integrated link. Compared with the method of FIG. 4, the method of FIG. 5 further includes transmitting the performance of content transmission through the p2 p connection to an external device after receiving the content to be shared through the p2 p connection (operation S136). The external device may be the content sharing relay server or the cloud service server.

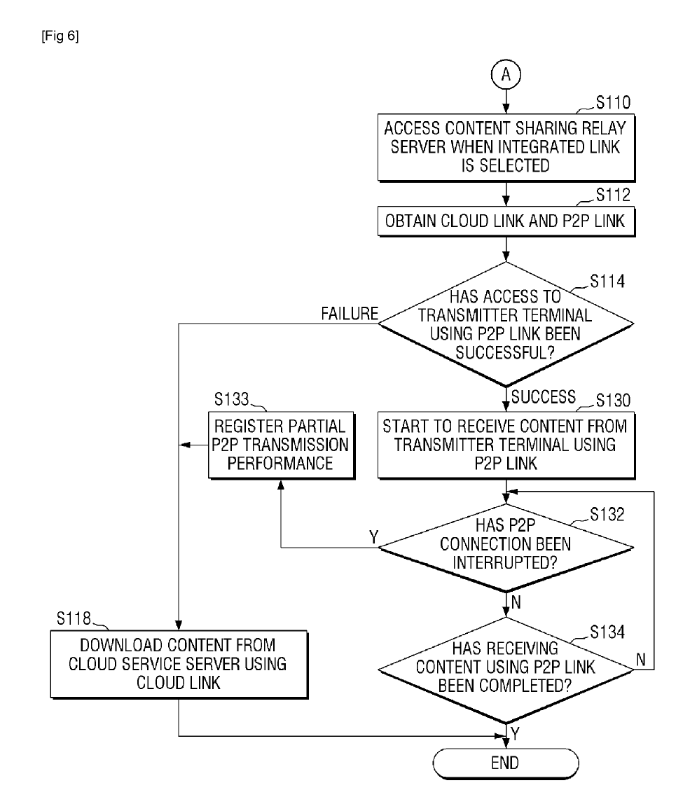

FIG. 6 is also a method performed by the receiver terminal which receives the integrated link. The method of FIG. 6 further includes, when the p2 p connection is interrupted while the receiver terminal is receiving the content through the p2 p connection (operation S130), automatically changing a receiving channel by receiving the content through the cloud link (operation S118).

The p2 p connection is interrupted for various reasons. For example, the communication may be unstable. Alternatively, while the transmitter terminal was able to communicate when content reception through the p2 p connection started, it may now be unable to communicate because, for example, it is powered off or has moved to a communication shadow area. These problems are related to inherent limitations of the p2 p connection. To overcome these problems, the current embodiment reduces the traffic use of the cloud service through content reception using the p2 p connection. In addition, when the p2 p connection is interrupted, the current embodiment enables content to be automatically downloaded from where it was interrupted through the cloud service, thereby supplementing the stability of content sharing.

In some embodiments, if the cloud service does not support downloading from where it was interrupted, content is downloaded again from the beginning.

Even if content reception through the p2 p connection is interrupted, if the cloud service supports downloading from where it was interrupted, the cloud service provider can save the amount of network traffic corresponding to the size of data transmitted through the p2 p connection. Therefore, according to the current embodiment, after the p2p connection is interrupted, the receiver terminal transmits the performance of partial content transmission through the p2 p connection to an external device using the size of data received through the p2 p connection (operation S133). The external device may be the content sharing relay server or the cloud service server.

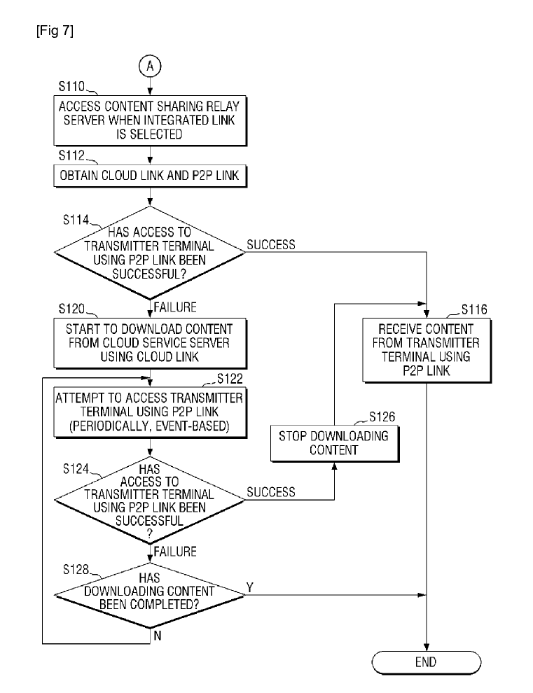

FIG. 7 is also a method performed by the receiver terminal which receives the integrated link. According to the current embodiment, even while the receiver terminal is downloading content through the cloud service because the p2 p connection is impossible, when the p2 p connection becomes possible, the receiver terminal automatically receives the content through the p2 p connection.

The receiver terminal accesses the integrated link (operation S110) and obtains the p2 p link and the cloud link (operation S112). Then, when failing to access the transmitter terminal using the p2 p link (operation S114), the receiver terminal starts to download content through the cloud link (operation S120). While downloading the content, the receiver terminal may receive an event alarm periodically or from an external device. In this case, the receiver terminal attempts to access the transmitter terminal using the p2p link (operation S122). This is because, for example, the transmitter terminal turned off when the receiver terminal started to download the content can be turned on while the receiver terminal is downloading the content. The event alarm may be received from the content sharing relay server. To provide the event alarm service, the content sharing relay server may monitor the connection state of each terminal registered therein.

When successfully accessing the transmitter terminal using the p2 p link (operation S124), the receiver terminal stops downloading the content through the cloud link (operation S126) and starts to receive the content through the p2 p link (operation S116). When the technology for transmitting and receiving content through the p2 p link supports downloading from where it was interrupted, the receiving of the content through the p2p link (operation S116) subsequent to the downloading of the content through the cloud link (operation S120) may be performed from where the downloading of the content was interrupted.

3. Sharing Before the Completion of Content Uploading

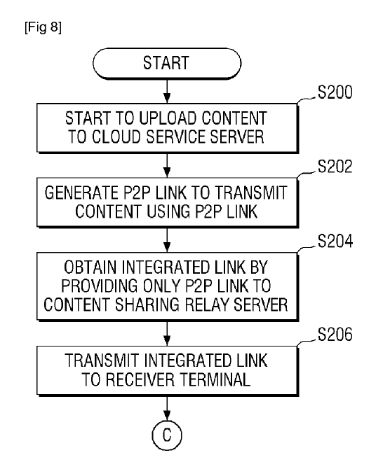

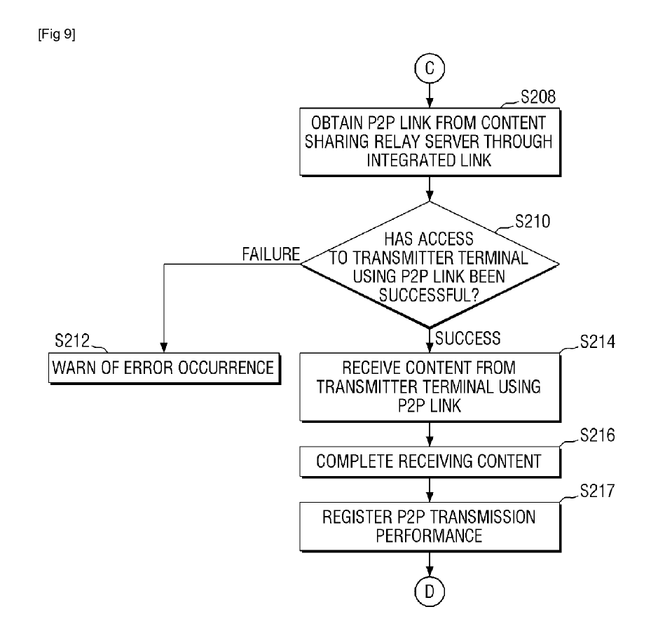

FIGS. 8 through 11 are flowcharts illustrating a content sharing method according to another embodiment of the present invention. The current embodiment is based on the assumption that content sharing is started before the completion of content uploading to a cloud service. FIG. 8 is a flowchart illustrating a method performed by a transmitter terminal which stores content to be shared. FIGS. 9 through 11 are flowcharts illustrating methods selectively performed by a receiver terminal after the method of FIG. 8 is performed.

Referring to FIG. 8, a transmitter terminal starts to upload content to a cloud service server (operation S200). Then, before the uploading of the content is completed, the transmitter terminal generates a p2 p link needed to transmit the content stored therein through p2 p connection by calling an API (included in the SDK described above) for generating a p2 p link (operation S202).

Next, the transmitter terminal requests a content sharing relay server to generate an integrated link by calling an API (included in the SDK) for requesting the generation of an integrated link and receives the integrated link generated by the content sharing relay server (operation S204). The API for requesting the generation of the integrated link is a parameter and requires the p2 p link only. In addition, when the API for requesting the generation of the integrated link is called, the transmitter terminal transmits the p2 p link to the content sharing relay server.

Next, the transmitter terminal transmits the integrated link to a receiver terminal (operation S206). The transmitter terminal may request the content sharing relay server to transmit the integrated link to the receiver terminal or may directly transmit the integrated link to the receiver terminal through an e-mail, a messenger, an SMS, etc.

FIG. 9 is a method performed by the receiver terminal which receives the integrated link.

Referring to FIG. 9, when receiving a user's input for selecting the integrated link, the receiver terminal accesses the content sharing relay server through the integrated link and receives the p2 p link from the content sharing relay server (operation S208).

The receiver terminal attempts to accesses the transmitter terminal using the p2p link (operation S210). When failing to access the transmitter terminal, the receiver terminal warns of an error situation in which there is no way to receive the content (operation S212). When successfully accessing the transmitter terminal, the receiver terminal receives the content from the transmitter terminal using the p2 p link (operation S214). After receiving the content, the receiver terminal transmits data about traffic saving performance through p2 p transmission to an external device (operation S217). The external device may be the content sharing relay server or the cloud service server.

When content sharing is possible only after content uploading to a cloud service is completed, large-volume content with a large data size, such as high-definition movies, can be shared only after a waiting period until the uploading of the large-volume content is completed. According to the current embodiment, however, such a problem can be solved. Therefore, content sharing is possible at the same time as content uploading to the cloud service.

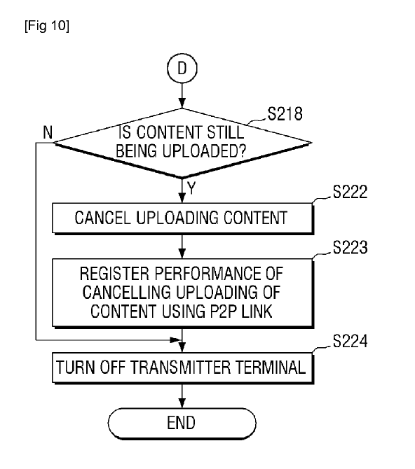

FIG. 10 is a method performed by the transmitter terminal after the completion of the operations of FIG. 9. While the uploading of content to the cloud service server and p2 p transmission are being performed simultaneously, the p2 p transmission can be completed first. Nonetheless, the uploading of the content to the cloud service server may still continue (operation S218). In this case, the uploading of the content to the cloud service server is cancelled (operation S222). In addition, the transmitter terminal transmits performance data related to the cancelling of the content uploading to the external device (operation S223). In addition, if a user of the transmitter terminal activated an automatic power-off setting, the transmitter terminal is automatically turned off since content transmission was completed (operation S224).

According to the current embodiment, a cloud service provider can save the consumption of network traffic and storage space due to the uploading of content already shared.

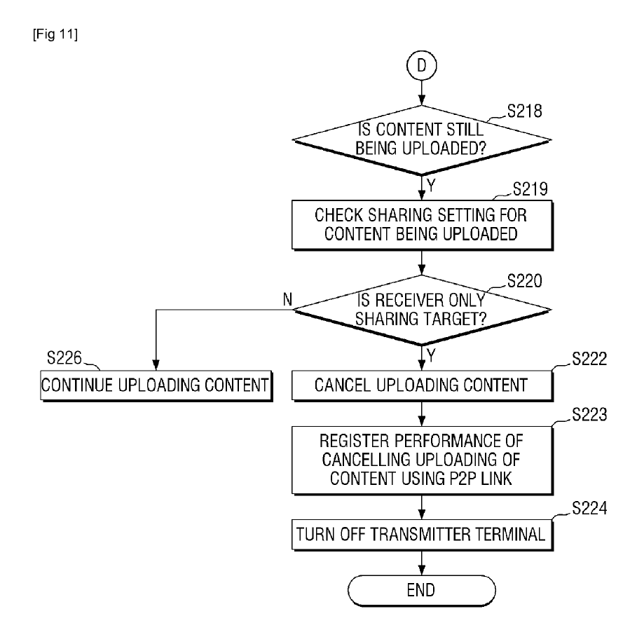

FIG. 11 is a method performed by the transmitter terminal after the completion of the operations of FIG. 9. In the method of FIG. 11, the uploading of content is cancelled only in a case where a receiver who has already received the content through the p2 p link is set as the only sharing target of the content being uploaded. This is because sharing targets other than the receiver who has already received the content through the p2 p link cannot receive the content if the content is not uploaded to the cloud service server.

Referring to FIG. 11, while the uploading of content to the cloud service server and p2 p transmission are being performed simultaneously, the p2 p transmission can be completed first. Nonetheless, the uploading of the content to the cloud service server may still continue (operation S218). In this case, a sharing setting for the content in the cloud service is checked. If the receiver who has already received the content through the p2p transmission is the only sharing target of the content (operation S220), the uploading of the content to the cloud service server is cancelled (operation S222). In addition, the transmitter terminal transmits performance data related to the cancelling of the content uploading to the external device (operation S223). In addition, if the user of the transmitter terminal activated the automatic power-off setting, the transmitter terminal is automatically turned off since content transmission was completed (operation S224). On the other hand, if there are sharing targets other than the receiver who has already received the content through the p2 p transmission (operation S220), the uploading of the content is continued (operation S226).

4. Billing and Rewarding for the Saving of Cloud Service Traffic

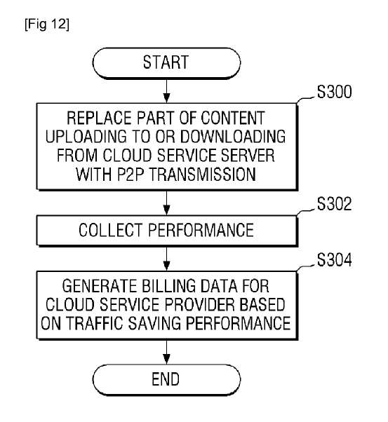

FIG. 12 is a flowchart illustrating a billing method for the saving of cloud service traffic according to another embodiment of the present invention. The billing method for the saving of the cloud service traffic according to the current embodiment or a rewarding method that accompanies the billing method or that can be provided independently will now be described with reference to FIG. 12.

According to various embodiments described above, content uploading to or content downloading from a cloud service server is partially replaced by p2 p transmission (operation S300), and the performance of the replacement is collected (operation S302). That is, a content sharing relay server generates an integrated link used to obtain a p2 p link of content stored in a transmitter terminal and a cloud link for downloading the content uploaded to the cloud service server. Then, the content sharing relay server collects from a receiver terminal which accessed the content sharing relay server through the integrated link information about the performance of receiving the content from the transmitter terminal through the p2 p link instead of downloading the content from the cloud service server.

The information about the performance may include data size information of the content received through the p2 p link from the transmitter terminal instead of being downloaded from the cloud service server, time information about when the content was received through the p2 p link, and transmitter and receiver information.

Next, the transmitter terminal generates billing data for an operator of the cloud service server using the information about the performance (operation S304). The billing data may be collected periodically and transmitted to a computing device of the operator of the cloud service server.

Although not illustrated in FIG. 12, at least one of the transmitter and the receiver may be rewarded for the saving of the cloud service traffic. That is, the content sharing relay server may issue a reward to at least one of a user account of the transmitter terminal and a user account of the receiver terminal by using the information about the collected performance. The reward may be provided by an operator of the content sharing relay server. Here, the reward may be calculated within a predetermined range of the profit generated by the billing process. The reward can also be provided by a provider of the cloud service.

5. Overall Service Flow

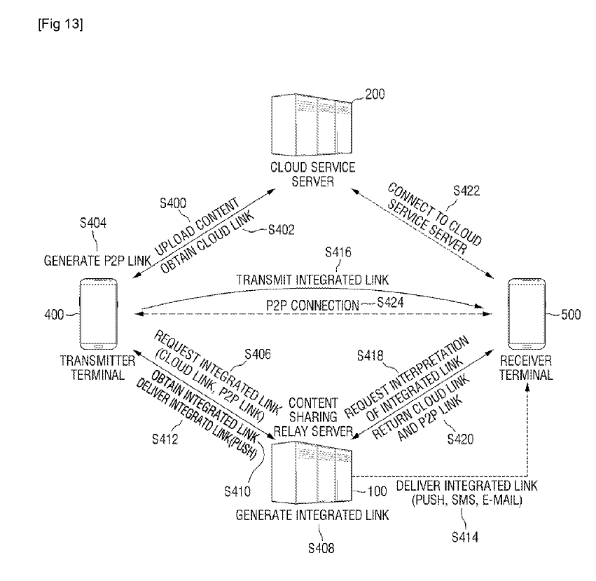

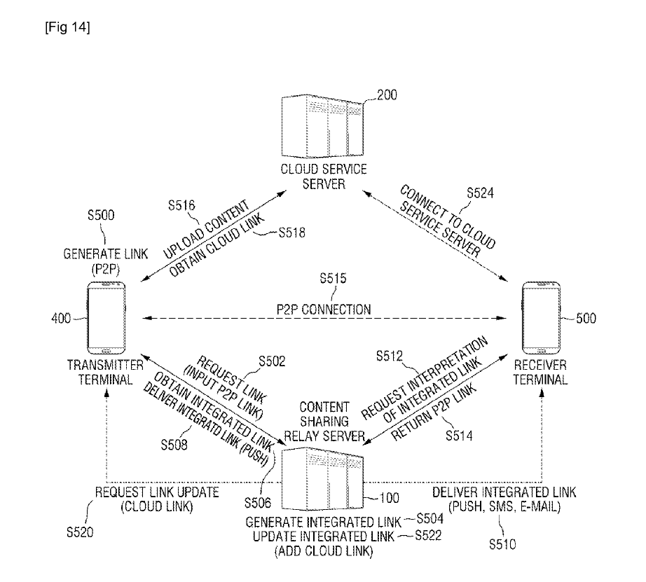

Embodiments of the present invention will now be summarized with reference to FIGS. 13 and 14. FIG. 13 illustrates an embodiment in which content sharing is started after content uploading. FIG. 14 illustrates an embodiment in which content uploading and content sharing are started simultaneously.

Referring to FIG. 13, a transmitter terminal 400 uploads content through a cloud service server 200 (operation S400) and then receives a cloud link indicating the uploaded content from the cloud service server 200 (operation S402). In addition, the transmitter terminal 400 generates a p2 p link for p2 p connection of the content stored therein (operation S404). Next, the transmitter terminal 400 requests a content sharing relay server 100 to generate an integrated link by providing the cloud link and the p2 p link to the content sharing relay server 100 (operation S406). In response to the request for the generation of the integrated link, the content sharing relay server 100 generates the integrated link (operation S408). The content sharing relay server 100 may transmit the generated integrated link to the transmitter terminal 400 (operation S410).

The transmitter terminal 400 transmits the integrated link directly to a receiver terminal 500 through an e-mail, a messenger, etc. (operation S416) or through the content sharing relay server 100 (operations S412 and S414).

The receiver terminal 500 accesses the content sharing relay server 100 using the integrated link (operation S418).

In an embodiment, the content sharing relay server 100 transmits the p2 p link and the cloud link corresponding to the integrated link to the receiver terminal 500 (operation S420). Here, the receiver terminal 500 first attempts to receive the content using the p2p link (operation S424). When failing to receive the content using the p2 p link, the receiver terminal 500 attempts to download the content through the cloud link (operation S422).

In another embodiment, when the p2 p link corresponding to the integrated link is currently accessible, the content sharing relay server 100 URL-redirects the integrated link to the p2 p link. When the p2 p link corresponding to the integrated link is currently not accessible, the content sharing relay server 100 URL-redirects the integrated link to the cloud link. In a case where the content sharing relay server 100 URL-redirects the integrated link, the receiver terminal 500 can download the content only by accessing the integrated link. Since the content sharing relay server 100 automatically selects an appropriate channel from the p2 p link and the cloud link, the receiver terminal 500 can download the content in a conventional way. In the case where the content sharing relay server 100 URL-redirects the integrated link, it can also generate performance data related to the saving of cloud service traffic resulting from p2 p connection without the help of the transmitter terminal 400 and the receiver terminal 500.

Referring to FIG. 14, a transmitter terminal 400 starts to upload content through a cloud service server 200 and generates a p2 p link for p2 p connection of the content stored therein (operation S500). Next, the transmitter terminal 400 requests a content sharing relay server 100 to generate an integrated link by providing the p2 p link to the content sharing relay server 100 (operation S502). In response to the request for the generation of the integrated link, the content sharing relay server 100 generates the integrated link (operation S504). The content sharing relay server 100 may transmit the generated integrated link to the transmitter terminal 400 (operation S506).

The transmitter terminal 400 transmits the integrated link directly to a receiver terminal 500 through an e-mail, a messenger, etc. or through the content sharing relay server 100 (operations S508 and S510).

The receiver terminal 500 accesses the content sharing relay server 100 using the integrated link (operation S512).

In an embodiment, the content sharing relay server 100 transmits the p2 p link corresponding to the integrated link to the receiver terminal 500 (operation S514). Unlike in the case of FIG. 13, since the uploading of the content through the cloud service server 200 has not been completed yet, a cloud link corresponding to the integrated link does not exist. Therefore, only the p2 p link is transmitted to the receiver terminal 500. The receiver terminal 500 attempts to receive the content using the p2 p link (operation S515). When failing to receive the content using the p2 p link, the receiver terminal 500 outputs an error message.

In another embodiment, when the p2 p link corresponding to the integrated link is currently accessible, the content sharing relay server 100 URL-redirects the integrated link to the p2 p link. In a case where the content sharing relay server 100 URL-redirects the integrated link, the receiver terminal 500 can download the content only by accessing the integrated link. Therefore, the receiver terminal 500 can download the content in a conventional way. In the case where the content sharing relay server 100 URL-redirects the integrated link, it can also generate performance data related to the saving of cloud service traffic resulting from p2 p connection without the help of the transmitter terminal 400 and the receiver terminal 500.

When the uploading of the content through the cloud service server 200 is completed (operation S516), the transmitter terminal 400 receives a cloud link indicating the uploaded content from the cloud service server 200 (operation S518). The transmitter terminal 400 requests the content sharing relay server 100 to update the integrated link by providing the cloud link to the content sharing relay server 100 (operation S520). The content sharing relay server 100 updates the integrated link by additionally matching the cloud link received from the transmitter terminal 400 to the integrated link (operation S522).

After the integrated link is updated, the receiver terminal 500 can receive the content regardless of whether it can receive the content from the transmitter terminal 400 using the p2 p link.

6. Configuration of a Content Sharing Relay Server

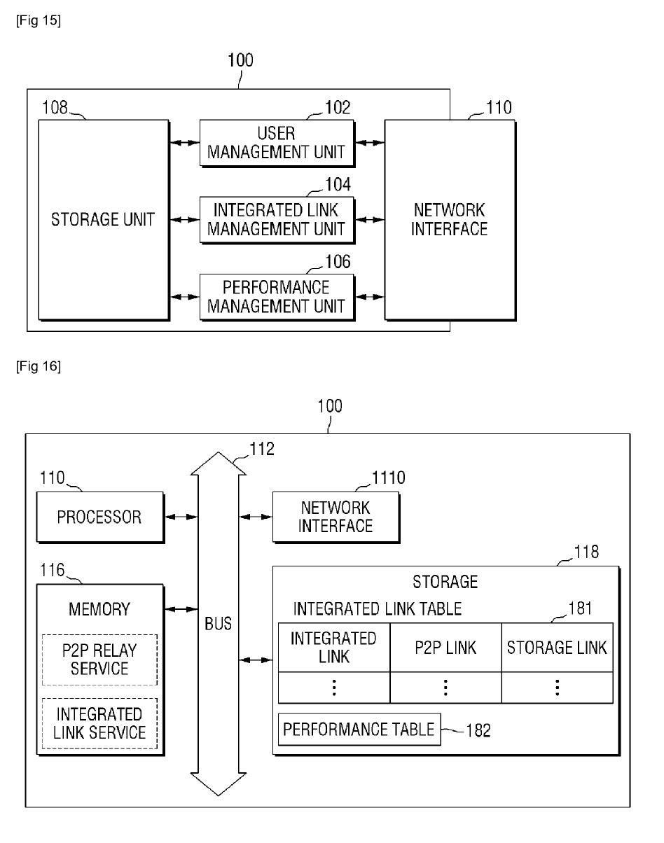

The configuration and operation of a content sharing relay server according to another embodiment of the present invention will now be described. FIG. 15 is a block diagram of a content sharing relay server 100 according to another embodiment of the present invention. Referring to FIG. 15, the content sharing relay server 100 according to the current embodiment includes a storage unit 108, a user management unit 102, an integrated link management unit 104, a performance management unit 106, and a network interface 110.

The user management unit 102 manages information about users registered with a content sharing service provided by the content sharing relay server 100. The information about the users is stored in the storage unit 108 according to a predetermined data structure. The content sharing service may be provided only to the registered users or to all users by processing an integrated link for all users.

The integrated link management unit 104 receives a p2 p link and a cloud link from a transmitter terminal through the network interface 110 and generates an integrated link for accessing any one of the p2 p link and the cloud link. When an integrated link for accessing the p2 p link only is generated first, it is later updated by including the cloud link. When access through the integrated link is made, the integrated link management unit 104 transmits the p2 p link and the cloud link corresponding to the integrated link in response to the access or URL-redirects the integrated link to any one of the p2 p link and the cloud link.

The performance management unit 106 collects information about the performance of receiving content from the transmitter terminal using the p2 p link instead of downloading the content from a cloud service server and generates billing data for an operator of the cloud service server using the collected information about the performance. The collected information about the performance may be received from the transmitter terminal or a receiver terminal. In an embodiment in which the integrated link management unit 104 URL-redirects the integrated link in response to the access through the integrated link, the performance management unit 106 may receive information about URL-redirection performance from the integrated link management unit 104 and configure the information about the performance.

FIG. 16 illustrates the hardware configuration of the content sharing relay server 100. Referring to FIG. 16, the content sharing relay server 100 may include a processor 110, a memory 116, a network interface 1110, a data bus 112, and a storage 118.

The processor 110 may be configured as one or more central processing units (CPUs) for performing operations. Software for performing a content sharing relay method according to an embodiment of the present invention may be loaded into the memory 116. The data bus 112 may be connected to the processor 110, the memory 116, the network interface 1110 and the storage 118 and serve as a data transmitting path between the components of the content sharing relay server 100.

The storage 118 stores a binary file (not illustrated) of the software for performing the content sharing relay method according to the embodiment of the present invention. The binary file is loaded into the memory 116 and executed by the processor 110. In addition, the storage 118 may further store a table 181 for managing integrated links and a performance table 182 for managing performance related to the saving of cloud service traffic.

A service logic may be loaded into the memory 116. The service logic is used to form a p2 p connection between a transmitter terminal and a receiver terminal by processing a p2 p link. In addition, an integrated link service logic may be loaded into the memory 116. The integrated link service logic may URL-redirect an integrated link to any one of a p2 p link and a storage link by processing the integrated link or transmit any one of the p2 p link and the storage link in response to access through the integrated link. The two service logics may be activated by loading the binary file of the software for performing the content sharing relay method into the memory 116.

7. Others

The method according to the embodiments described above with reference to FIGS. 2 through 16 can be executed by a computer program implemented as computer-readable code. The computer program can be transmitted from a first computing device to a second computing device through a network such as the Internet. Then, the computer program can be installed in and used by the second computing device. Examples of the first computing device and the second computing device include server devices, fixed computing devices such as desktop personal computers (PCs), mobile computing devices such as notebook computers, smartphones and tablet PCs, and wearable computing devices such as smart watches and smart glasses.

According to the present invention, network traffic and storage space generated directly or indirectly between a cloud service providing device and a user terminal can be saved through p2 p connection between users who share content with each other.

In addition, receiving content through p2 p connection was possible only when a transmitter terminal was turned on. However, the present invention can solve this problem by downloading content using a cloud service when the transmitter terminal is turned off. Therefore, content can be received at any time.

Furthermore, when content sharing is possible only after content uploading to the cloud service is completed, large-volume content with a large data size, such as high-definition movies, can be shared only after a waiting period until the uploading of the large-volume content is completed. However, the present invention can solve this problem. Therefore, content sharing is possible at the same time as content uploading to the cloud service.

What is claimed is:

1. A content sharing method comprising:
receiving an integrated link for accessing any one of a first link and a second link from an external device; and
attempting to access the first link through the integrated link and then attempting to access the second link only when failing to access the first link,
wherein the first link is used to receive content through peer-to-peer (p2p) data transmission and reception, and the second link is used to download content from a data storage device which is connected to a network so as to provide a content storage service.

2. The content sharing method of claim 1, wherein the integrated link is issued by a content sharing relay server and indicates the content sharing relay server.

3. A content sharing method comprising:
receiving from a transmitter terminal an integrated link used to obtain a p2 p link of content stored in the transmitter terminal and a cloud link for downloading the content uploaded to a cloud service server;
accessing a content sharing relay server using the integrated link and receiving the p2 p link and the cloud link from the content sharing relay server;
attempting to receive the content using the p2 p link; and
attempting to download the content using the cloud link when failing to receive the content using the p2 p link.

4. The content sharing method of claim 3, further comprising, when the receiving of the content using the p2 p link is completed, transmitting information about the performance of traffic saving resulting from the receiving of the content using the p2 p link to the content sharing relay server.

5. The content sharing method of claim 3, further comprising, when disconnected from the transmitter terminal while receiving the content using the p2 p link, attempting to receive the content using the cloud link from where the receiving of the content was interrupted and transmitting information about the performance of partial traffic saving resulting from the receiving of the content using the p2 p link to the content sharing relay server.

6. The content sharing method of claim 3, further comprising:
receiving the content using the p2 p link when successfully attempting to receive the content using the p2 p link; and
automatically attempting to download the content using the cloud link when p2p connection is interrupted while the content is being received using the p2 p link.

7. The content sharing method of claim 3, wherein the attempting to download the content using the cloud link when failing to receive the content using the p2 p link comprises:
checking whether p2 p connection using the p2 p link is possible while downloading the content; and
starting to receive the content using the p2 p link when the p2 p connection is possible.

8. A content sharing relay method comprising:
receiving from a transmitter terminal a p2 p link for content stored in the transmitter terminal and a cloud link for downloading the content uploaded to a cloud service server;
generating an integrated link using the p2 p link and the cloud link; and
in response to access by a receiver terminal through the integrated link, universal resource locator (URL)-redirecting the integrated link to the p2 p link when the transmitter terminal is able to communicate using the p2 p link and URL-redirecting the integrated link to the cloud link when the transmitter terminal is unable to communicate using the p2p link.

9. The content sharing relay method of claim 8, further comprising:
collecting the performance of URL-redirecting the integrated link to the p2 p link; and
generating billing data for an operator of the cloud service server using the collected performance.

10. The content sharing relay method of claim 9, further comprising allocating a portion of a billing amount corresponding to the billing data to a user account of the transmitter terminal as a reward.

11. A content sharing method comprising:
receiving an integrated link used to access a p2 p link for content stored in a transmitter terminal from the transmitter terminal by using a receiver terminal;
first attempting to access the p2 p link through the integrated link by using the receiver terminal;
receiving content from the transmitter terminal using the p2 p link after accessing the p2 p link by using the receiver terminal; and
attempting to access a cloud link, which has been newly matched to the integrated link as a result of updating the integrated link, through the integrated link when disconnected from the transmitter terminal while receiving the content from the transmitter terminal by using the receiver terminal,
wherein the cloud link is used to download the content uploaded to a cloud service server.

12. The content sharing method of claim 11, further comprising:
completely uploading the content to the cloud service server while transmitting the content to the receiver terminal using the p2 p link by using the transmitter terminal;
receiving the cloud link from the cloud service server by using the transmitter terminal; and
requesting a content sharing relay server to update the integrated link by providing the cloud link to the content sharing relay server by using the transmitter terminal.

13. The content sharing method of claim 12, wherein the requesting of the content sharing relay server to update the integrated link comprises automatically turning off the transmitter terminal after requesting the content sharing relay server to update the integrated link.

14. A content sharing method comprising:
generating a p2 p link indicating stored content;
starting to upload the content to a cloud service server;
requesting a content sharing relay server to generate an integrated link by transmitting the p2 p link to the content sharing relay server before the uploading of the content is completed;
transmitting the integrated link to a receiver terminal directly or through the content sharing relay server before the uploading of the content is completed;
starting to transmit the content using the p2 p link when requested by the receiver terminal to transmit the content using the p2 p link; and
cancelling the uploading of the content to the cloud service server when the transmitting of the content using the p2 p link is completed before the uploading of the content to the cloud service server is completed.

15. The content sharing method of claim 14, wherein the cancelling of the uploading of the content to the cloud service server comprises cancelling the uploading of the content to the cloud service server only when a sharing setting of the cloud service server for the content being uploaded indicates that the content is to be shared only with a user of the receiver terminal.

16. The content sharing method of claim 14, further comprising:
receiving a cloud link for downloading the uploaded content from the cloud service server when the uploading of the content to the cloud service server is completed before the transmitting of the content using the p2 p link is completed; and
requesting the content sharing relay server to update the integrated link by providing the cloud link to the content sharing relay server.

17. A billing method for the saving of cloud service traffic, the billing method comprising:
generating an integrated link used to obtain a p2 p link of content stored in a transmitter terminal and a cloud link for downloading the content uploaded to a cloud service server;
collecting information about the performance of receiving the content from the transmitter terminal using the p2 p link instead of downloading the content from the cloud service server; and
generating billing data for an operator of the cloud service server using the collected information about the performance.

18. The billing method of claim 17, wherein the information about the performance comprises data size information of the content received from the transmitter terminal using the p2 p link instead of being downloaded from the cloud service server.

19. A rewarding method for the saving of cloud service traffic, the rewarding method comprising:
generating an integrated link used to obtain a p2 p link of content stored in a transmitter terminal and a cloud link for downloading the content uploaded to a cloud service server;
collecting from a receiver terminal which accessed through the integrated link, information about the performance of receiving the content from the transmitter terminal using the p2 p link instead of downloading the content from the cloud service server; and
issuing a reward for at least one of a user account of the transmitter terminal and a user account of the receiver terminal by using the collected information about the performance.

20. An apparatus for saving cloud service traffic, the apparatus comprising:
a network interface;
one or more processors;
a memory which is loaded with a computer program executed by the processors;
a storage which stores an integrated link table comprising a p2 p link of content stored in a transmitter terminal, a cloud link for downloading the content uploaded to a cloud service server, and matching information of an integrated link provided to a receiver terminal to access the p2 p link and the cloud link,
wherein the computer program comprises:
an operation of receiving the p2 p link and the cloud link through the network interface and generating the integrated link to access the p2 p link and the cloud link; and
an operation of, in response to access by the receiver terminal through the integrated link, URL-redirecting the integrated link to the p2 p link when the transmitter terminal is able to communicate using the p2 p link and URL-redirecting the integrated link to the cloud link when the transmitter terminal is unable to communicate using the p2 p link.

21. The apparatus of claim 20, wherein the computer program further comprises:
an operation of managing information about the performance of receiving the content from the transmitter terminal using the p2 p link instead of downloading the content from the cloud service server; and
an operation of generating billing data for an operator of the cloud service server using the collected information about the performance.
